(19) United States
(12) Patent Application Publication
(10) Pub. No.: US 2006/0289681 A1
(43) Pub. Date: Dec. 28, 2006

(54) Injection nozzle for internal combustion engines

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/538,030

(22) PCT Filed: Apr. 23, 2004
(86) PCT No.: PCT/DE04/00846

§ 371 Date: Jun. 8, 2005

(30) Foreign Application Priority Data
Jun. 10, 2003 (DE) 103 26 045.5

(51) Int. Cl. F02M 43/00

(52) U.S. Cl. 239/533.3

(57) ABSTRACT

An injection nozzle for an internal combustion engine, having a nozzle body with a first nozzle needle for controlling at least one first injection opening and a second nozzle needle for controlling at least one second injection opening. A first drive piston is coupled to the first nozzle needle and is equipped with a first booster surface hydraulically coupled to a control surface of a control piston by a first hydraulic pressure transmission path, a second drive piston coupled to the second nozzle needle has a second booster surface that an activatable and deactivatable second hydraulic pressure transmission path is able to hydraulically couple to a control surface of the control piston; the activation and deactivation of the second hydraulic pressure transmission path is controlled as a function of the control piston stroke.

### PRIOR ART

The present invention relates to an injection nozzle for internal combustion engines, with the characteristics of the preamble to claim 1.

An injection nozzle of this kind is known, for example, from DE 100 58 153 A1 and has a nozzle body equipped with at least one first injection opening and at least one second injection opening. A first nozzle needle embodied in the form of a hollow needle, which controls the injection of fuel through the at least one first injection opening, is guided in a first needle guide of the nozzle body. A second nozzle needle, which controls the injection of fuel through the at least one second injection opening, is guided coaxially inside the first nozzle needle. In the known injection nozzle, the second nozzle needle is drive-connected to a drive piston that has a control surface, which is situated in a control chamber and acts in the closing direction when subjected to pressure. The second nozzle needle is equipped with a pressure shoulder, i.e. a cross-sectional area of a second valve seat situated between the second nozzle needle and the nozzle body is smaller than a cross-sectional area of a second needle guide provided to guide the second nozzle needle inside the first nozzle needle. When the first nozzle needle is open, the pressure shoulder of the second nozzle needle is subjected to pressure and this pressure shoulder of the second nozzle needle acts in the opening direction. If the first nozzle needle is open and the second nozzle needle should also be opened, then the pressure in the control chamber can be reduced so that the opening force acting on the pressure shoulder of the second nozzle needle predominates. The cost required for actuating the second nozzle needle here is relatively high.

### ADVANTAGES OF THE INVENTION

The injection nozzle according to the present invention, with the characteristics of the independent claim, has the advantage over the prior art that only a single actuator is required in order to trigger both nozzle needles. This simplifies the design of the injection nozzle significantly, thus permitting it to be manufactured at a more reasonable price.

The invention is based on the general concept of controlling the pressures acting on the drive pistons of the two nozzle needles by using only a single control piston; a hydraulic pressure transmission path is provided between the control piston and the respective drive piston used to actuate the associated nozzle needle. Whereas the first hydraulic pressure transmission path, which is embodied between the control piston and the first drive piston provided to actuate the first nozzle needle, remains permanently active, it is possible according to the present invention for the second hydraulic pressure transmission path, which is embodied between the control piston and the second drive piston provided to actuate the second nozzle needle, to be embodied as controllable, thus permitting the second hydraulic transmission path to be switched between an activated and a deactivated state. The switching between the activated state and deactivated state is controlled as a function of the control piston stroke. This means that an opening stroke of the control piston always triggers an opening stroke of the first nozzle needle and, after the stroke-controlled switching between the deactivated state and the activated state, also triggers an opening stroke of the second nozzle needle.

It is thus possible to trigger both nozzle needles directly, using only a single control piston, i.e. with a single actuator, which simplifies the design of the injection nozzle according to the present invention. In addition, it is possible to improve the injection behavior or injection characteristic of the injection nozzle and in particular, to achieve extremely short injection times.

According to a particularly advantageous modification, it is possible to switch the second hydraulic pressure transmission path between its activated and deactivated states at a predetermined control piston stroke; this control piston stroke is selected so that with an opening stroke motion of the control piston up to the point at which it reaches the predetermined control piston stroke, the first nozzle needle executes an opening stroke while the second nozzle needle remains in its closed position, and that when the opening stroke motion of the control piston travels beyond the predetermined control piston stroke, the second nozzle needle also executes an opening stroke. The predetermined control piston stroke consequently defines a stroke range for the control piston in which the control piston only actuates the first nozzle needle. Only when an opening stroke travels beyond the predetermined control piston stroke does the control piston also actuate the second nozzle needle. This makes it possible to execute a fuel injection in a particularly simple fashion, either by means of only the at least one first injection opening or by means of both the at least one first injection opening and the at least one second injection opening. In this connection, it is possible to select virtually any amount of time between the opening of the first nozzle needle and the opening of the second nozzle needle.

According to particularly advantageous embodiment forms, a controllable hydraulic connection is able to connect a second control chamber, which serves to actuate the second drive piston, to a supply line, which supplies highly pressurized fuel to the injection openings. This hydraulic connection is triggered to open and close as a function of the control piston position; the second hydraulic pressure transmission path is deactivated when the hydraulic connection is open and is activated when the hydraulic connection is closed. In this embodiment form, the incompressibility of the hydraulic medium used, i.e. the fuel, is utilized for the activation and deactivation of the second pressure transmission path. As long as the hydraulic connection is open, the second control chamber communicates with the supply line so that the second pressure transmission path to the supply line is open. It is possible for hydraulic medium displaced within the second pressure transmission path, which is either fed into the second control chamber or is displaced or aspirated from the second control chamber, to then be discharged directly into the supply line or be replenished from the supply line. As a result, the pressure in the second control chamber remains virtually constant and corresponds to the pressure that is present in the supply line.

But as soon as the hydraulic connection is closed, the second pressure transmission path is also closed in a virtually hermetic fashion, at least for dynamic events, as a result of which hydraulic medium, which is fed into the second control chamber or is displaced or aspirated from the second control chamber, generates a corresponding pressure increase or pressure decrease in the second control chamber.

In a suitable modification, it is possible for a segment of the hydraulic connection to be contained in the control piston. This design produces a direct interrelationship between the control piston stroke and the switch actuation of the second pressure transmission path.

In another embodiment form, it is possible for the controllable hydraulic connection to be situated within the second pressure transmission path; the hydraulic connection is then able to connect a first booster chamber, which contains a first booster surface of the first drive piston, to a second booster chamber, which contains a second booster surface of the second drive piston. The hydraulic connection is once again controlled to open and close as a function of the control piston position; by contrast with the embodiment form described previously, the second pressure transmission path is activated when the hydraulic connection is open and is deactivated when the hydraulic connection is closed. This embodiment form simplifies the design of the hydraulic path routing inside the injection nozzle since it permits the second pressure transmission path to coincide with the first pressure transmission path up to the controllable hydraulic connection.

In a suitable modification of this, a segment of the hydraulic connection is provided in the first drive piston. Correspondingly, the hydraulic connection is only controlled indirectly as a function of the control piston stroke and directly as a function of the opening stroke of the first nozzle needle drive-connected to the first drive piston. This is particularly advantageous since it allows the second nozzle needle to be triggered to open precisely when the first nozzle needle has executed a predetermined preliminary stroke during its opening.

Other important characteristics and advantages of the injection nozzle according to the present invention ensue from the dependent claims, the drawings, and the accompanying description of the figures contained in the drawings.

### DRAWINGS

Exemplary embodiments of the injection nozzle according to the present invention are shown in the drawings and will be explained in detail below; components which are the same, similar, or functionally equivalent have been labeled with the same reference numerals.

FIGS. 1-4 show very simplified schematic longitudinal sections through various embodiment forms of an injection nozzle according to the present invention.

### DESCRIPTION OF THE EXEMPLARY EMBODIMENTS

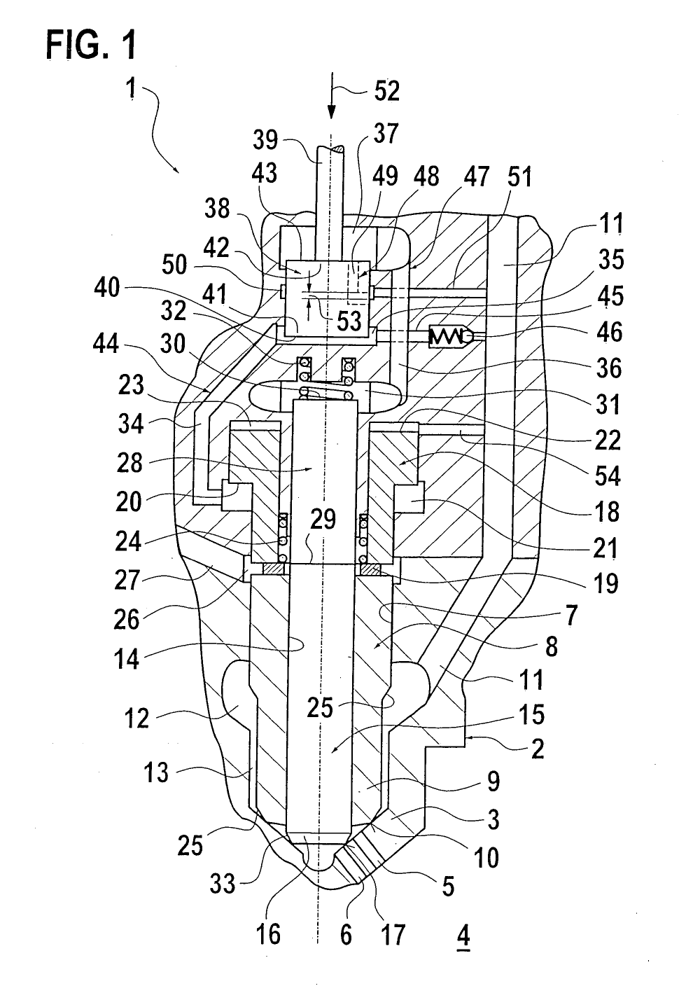

An injection nozzle 1 according to the present invention shown in FIG. 1 has a nozzle body 2 that is only partially depicted. The injection nozzle 1 supplies fuel to a cylinder of an internal combustion engine, in particular in a motor vehicle. When installed, a nozzle tip 3 protrudes into a combustion chamber 4 or premixing chamber 4 of the respective cylinder in such a way that with an appropriate actuation of the injection nozzle 1, it is possible for at least one first injection opening 5 and at least one second injection opening 6 to inject fuel into the combustion chamber/premixing chamber 4. It is clearly possible for the injection nozzle 1 to have a number of first injection openings 5 and/or a number of second injection openings 6 that are respectively distributed in a suitable annular pattern around the circumference of the nozzle needle tip 3.

The nozzle body 2 has a first needle guide 7 in which a first nozzle needle 8 is supported so that it is able to execute a stroke motion. The first nozzle needle 8 serves to control the at least one first injection opening 5. To this end, between the nozzle tip 3 and a first needle tip 9 of the first nozzle needle 8 oriented toward the injection openings 5, 6, a first sealing seat 10 is provided, which is situated upstream of the at least one first injection opening 5 in relation to a fuel supply of the at least one first injection opening 5.

Fuel is supplied to the injection openings 5, 6 by means of a supply line 11, which is contained in the nozzle body 2, supplied with highly pressurized fuel at its input end, and feeds into a nozzle chamber 12 at its outlet end. An annular chamber 13 situated radially between the first nozzle needle 8 and the nozzle body 2 leads from the nozzle chamber 12 to the injection openings 5, 6. In order to supply the supply line 11 with highly pressurized fuel, it is possible for the supply line 11 to be connected to a high-pressure accumulator, not shown here, which is supplied by a high-pressure pump and is connected to the supply lines 11 of a number of injection nozzles 1 (“common rail” principle). It is also possible to connect the supply line 11 directly to a corresponding high-pressure pump.

The first nozzle needle 8 is embodied in the form of a hollow needle and contains a second needle guide 14 in which a second nozzle needle 15 is supported so that it is able to execute a stroke motion coaxial to the first nozzle needle 8. The second nozzle needle 15 controls the at least one second nozzle needle 6. To this end, between the nozzle tip 3 and a second needle tip 16 oriented toward the injection openings 5, 6, a second sealing seat 17 is provided, which is situated downstream of the at least one first injection opening 5 and upstream of the at least one second injection opening 6. The sealing seats 10, 17 each extend in annular and linear fashion in the circumference direction.

When the first nozzle needle 8 is closed, both the at least one first injection opening 5 and the at least one second injection opening 6 are disconnected from the fuel supply. When the first nozzle needle 8 is open and the second nozzle needle 15 is closed, the at least one first injection opening 5 communicates with the fuel supply, whereas the at least one second injection opening 6 is disconnected from the fuel supply. When both nozzle needles 8, 15 are open, all of the injection openings 5, 6 communicate with the fuel supply.

In order to drive the first nozzle needle 8, a first drive piston 18 is provided, which is supported so that it is able to execute a stroke motion in the nozzle body 2 and is drive-coupled to the first nozzle needle 8. In the embodiment form shown here, the first drive piston 18 rests against the first nozzle needle 8 by means of a washer 19. Since forces that press the first drive piston 18 against the first nozzle needle 8 act on the first drive piston 18 and the first nozzle needle 8 continuously during operation of the injection nozzle 1, it is not absolutely necessary for the first nozzle needle 8 to be attached to the first drive piston 18. It is therefore possible, in particular, for the individual components (first nozzle needle 8, washer 19, first drive piston 18) to rest loosely against one another. The above-mentioned components 8, 19, 18 constitute a functional unit that is able to execute a stroke motion as a whole. In another embodiment form, the first drive piston 18 is attached to the first nozzle needle 8; in particular, it is also possible for the first drive piston 18 and the first nozzle needle 8 to be embodied of one piece with each other.

The first drive piston 18 has a first booster surface 20 that is contained in a first booster chamber 21 and can be subjected to a pressure therein. The first booster surface 20 is oriented toward the injection openings 5, 6 and consequently acts in the opening direction of the first nozzle needle 8 when subjected to pressure. The first drive piston 18 also has a first compensator surface 22 that is contained in a first compensator chamber 23 and can be subjected to a pressure therein. The first compensator surface 22 is oriented in the opposite direction from the first booster surface 20 and is consequently oriented away from the injection openings 5, 6 so that the first compensator surface 22 acts in the closing direction of the first nozzle needle 8 when subjected to pressure. In addition, a first spring 24 is provided, which prestresses the first nozzle needle 8 in the closing direction. To this end, the first spring 24 here rests against the nozzle body 2 at one end and rests against the first nozzle needle 8 by means of the washer 19 at the other end. The first nozzle needle 8 is also equipped with a first pressure shoulder 25 that is oriented toward the injection openings 5, 6 and consequently acts in the opening direction of the first nozzle needle 8 when subjected to pressure. The first pressure shoulder 25 is constituted by the difference between the cross-sectional area of the first needle guide 7 and the cross-sectional area of the first sealing seat 10. The first pressure shoulder 25 here is contained partially in the nozzle chamber 12 and partially in the annular chamber 13.

In the region of the washer 19, a leakage chamber 26 is provided in the nozzle body 2 and communicates with a relatively unpressurized reservoir, e.g. the fuel tank, via a leakage conduit 27. This leakage conduit 26 also accommodates the first spring 24.

In order to drive the second nozzle needle 15, a second drive piston 28 is provided that is drive-coupled to the second nozzle needle 15 in a suitable fashion. Analogous to the coupling between the first drive piston 18 and the first nozzle needle 8, it is also possible for the second drive piston 28 to rest loosely against the second nozzle needle 15 at a separation line 29. It is also possible for the second drive piston 28 to be attached to the second nozzle needle 15. In any case, the second drive piston 28 and second nozzle needle 15 also constitute a functional unit that is able to execute a stroke motion as a whole. The second drive piston 28 has a second booster surface 30 that is contained in a second booster chamber 31 and can be subjected to a pressure therein. The second booster surface 30 is oriented away from the injection openings 5, 6 and consequently acts in the closing direction of the second nozzle needle 15 when subjected to pressure. In the region of the second booster chamber 31, a second spring 32 is provided, which prestresses the second nozzle needle 15 in the closing direction. To this end, the second spring 32 rests against the nozzle body 2 at one end and at the other end, rests against the second nozzle needle 15 by means of the second booster surface 30 of the second drive piston 28.

The second nozzle needle 15 is equipped with a second pressure shoulder 33, which is constituted by the difference between the cross-sectional area of the second needle guide 14 and the cross-sectional area of the second sealing seat 17. When subjected to pressure, the second pressure shoulder 33 acts in the opening direction of the second nozzle needle 15. When the first nozzle needle 8 is closed, the second pressure shoulder 33 is inactive so that the full closing forces of the second spring 32 and the second booster surface 30 are in effect. When the first nozzle needle 8 is open, the second pressure shoulder 33 is subjected to a pressure that acts on the second nozzle needle 15 in the opening direction and reduces the opening forces required to open the second nozzle needle 15.

A first control conduit 34 connects the first booster chamber 21 to a first control chamber 35. A second control conduit 36 also connects the second booster chamber 31 to a second control chamber 37 in a corresponding manner.

The injection nozzle 1 also has a control piston 38 that is supported so that it is able to execute a stroke motion in the nozzle body 2. The control piston 38 is drive-connected to an actuator, not shown in FIG. 1, e.g. via a push rod 39. The control piston 38 has a first control surface 40, which is situated at a first end 41 of the control piston 38, is contained in the first control chamber 35, and can be subjected to a pressure therein. At a second end 42 oriented away from the first end 41, the control piston 38 has a second control surface 43, which is situated in the second control chamber 37 and can be subjected to a pressure therein.

Between the control piston 38 and the first drive piston 18, a first hydraulic pressure transmission path 44 is thus provided, which hydraulically couples the first booster surface 20 to the first control surface 40. The first control chamber 35 communicates with the supply line 11 via an inlet line 45; the inlet line 45 contains an inlet valve 46, which in this instance is embodied in the form of a check valve that is designed to permit a flow toward the first control chamber 35 and prevent a flow in the direction toward the supply line 11. As a result, at least approximately the same pressure as in the supply line 11 is present in the first control chamber 35 and therefore in the first booster chamber 21.

Between the control piston 38 and the second drive piston 28, there is a corresponding second hydraulic pressure transmission path 47 that hydraulically couples the second control surface 43 to the second booster surface 30. A hydraulic connection 48 is able to connect the second booster chamber 37 to the supply line 11 so that in the state in which the communication is open, the same pressure as in the supply line 11 is present in the second control chamber 37 and therefore also in the second booster chamber 31. The hydraulic connection 48 is designed so that it can be opened and closed. This is achieved by virtue of the fact that the hydraulic connection 48 is routed in the nozzle body 2 so that the control piston 38 functions like a slide valve and opens or closes the hydraulic connection 48 as a function of its stroke position.

In the current instance, a segment 49 of the hydraulic connection 48 is provided inside the control piston 38. This segment 49 communicates with the second control chamber 37 at one end and at the other end, communicates with an annular chamber 50 of the hydraulic connection 48, which communicates with the supply line 11 via a conduit 51 of the hydraulic connection 48. In the initial position depicted here, there is thus an overlap between the annular chamber 50 and the end of the segment 49 oriented toward the annular chamber 50 so that the hydraulic connection 48 is open.

During a stroke motion of the control piston 38 in an opening direction 52 indicated by an arrow, the connection between the segment 49 and the annular chamber 50 is disconnected after a predetermined stroke distance 53 has been achieved, i.e. the hydraulic connection 48 is then disconnected and there is no longer any communicating connection between the supply line 11 and the second control chamber 37.

A compensator conduit 54 connects the compensator chamber 23 to the supply line 11.

The embodiment form of the injection nozzle 1 according to the present invention shown in FIG. 1 functions as follows:

In the initial position depicted in FIG. 1, both of the nozzle needles 8, 15 are closed. The pressure of the supply line 11 is present in the compensator chamber 23 and in the nozzle chamber 12. The pressure of the supply line 11 is likewise present in the first control chamber 35 and therefore in the first booster chamber 21. Since the hydraulic connection 48 is open in this initial position, the same pressure as in the supply line 11 also prevails in the second control chamber 37 and therefore in the second booster chamber 31. The balance of forces acting on the unit comprised of the first nozzle needle 8 and first drive piston 18 yields a resulting force acting in the closing direction. In the same way, the balance of forces acting on the unit comprised of the second nozzle needle 15 and second drive piston 28 also yields a force acting in the closing direction.

If fuel is to be injected through the at least one first injection opening 5 into the combustion chamber or premixing chamber 4, then the control piston 38 is moved in the opening direction 52. This causes the first control surface 40 of the control piston 38 to plunge into the first control chamber 35. The resulting pressure increase is transmitted via the first hydraulic pressure transmission path 44 directly into the first booster chamber 21 and consequently to the first booster surface 20. This changes the balance of forces acting on the first drive piston 18, yielding a force acting on the first nozzle needle 8 in the opening direction. Correspondingly, the first nozzle needle 8 lifts away from the first sealing seat 10. When the first nozzle needle 8 is open, the at least one first injection opening 5 is connected to the nozzle chamber 12 and is therefore able to inject fuel into the combustion chamber or premixing chamber 4.

When the first nozzle needle 8 is open, the high pressure that is present in the supply line 11 also builds up against the second pressure shoulder 33 of the second nozzle needle 50, thus changing the balance of forces acting on the unit comprised of the second nozzle needle 15 and second drive piston 28. But the forces acting in the closing direction nevertheless predominate and the second nozzle needle 15 remains closed.

As long as the opening stroke motion of the control piston 38 is shorter than the stroke distance 53, the hydraulic connection 48 remains open. As a result of this, during the stroke motion of the control piston 38, no pressure drop occurs in the second control chamber 37 even though the second control surface 43 of the control piston 38 is traveling out of the second control chamber 37 and thus enlarging the volume of the second control chamber 37. The open hydraulic connection 48 permits a replenishing supply of hydraulic medium, i.e. fuel, to flow into the second control chamber 37, driven by the high pressure in the supply line 11. The pressure in the second control chamber 37 and therefore also in the second booster chamber 31 thus remains essentially unchanged.

The volume increase in the second control chamber 37 generated by the stroke motion of the control piston 38 does not result in a pressure drop in the second control chamber 37 since the open hydraulic connection 48 is able to immediately replace the missing volume. Consequently, the second hydraulic pressure transmission path 47 cannot transmit any pressure change from the second control surface 43 to the second booster surface 30 so that the second hydraulic pressure transmission path 47 is inactive or deactivated when the hydraulic connection 48 is open.

If the fuel injection via the at least one first injection opening 5 is insufficient and a fuel injection should also be executed via the at least one second injection opening 6, then the control piston 38 is moved in the opening direction 52 beyond the stroke distance 53. This first closes the hydraulic connection 48 so that the hydraulic volume contained in the second hydraulic pressure transmission path 47 is hermetically closed. The second hydraulic pressure transmission path 47 is thus activated, which enables it to transmit changes in the pressure acting on the second control surface to the second booster surface 30. This means that when the control piston 38 executes a stroke motion that travels beyond the stroke distance 53, the increase in the volume of the second control chamber 37 produces a pressure drop in the second control chamber 37. The second hydraulic pressure transmission path 47 transmits this pressure drop directly into the second booster chamber 31 so that the second booster surface 30 is also subjected to the reduced pressure. This changes the balance of forces acting on the unit comprised of the second drive piston 28 and second nozzle needle 15 once again so that now, a resulting force acting in the opening direction is produced. Consequently, the second nozzle needle 15 lifts away from the second sealing seat 17.

Then the at least one second injection opening 6 is also connected to the nozzle chamber 12 and is able to inject fuel into the premixing chamber or combustion chamber 4.

To close the second nozzle needle 15, it is possible for the control piston 38 to be moved back to the stroke distance 53, which reopens the hydraulic connection 48 and permits a pressure compensation of the supply line 11 in relation to the second control chamber 37 and consequently also the second booster chamber 31. As a result, the closing forces acting on the unit comprised of the second drive piston 28 and second nozzle needle once again predominate, causing the second nozzle needle 15 to close.

If the first nozzle needle 8 should also then be closed, the control piston 38 travels back into its initial position, as a result of which the volume increase in the first control chamber 35 triggers a pressure drop in the first control chamber 35 and in the first booster chamber 21. The resulting change in the balance of forces acting on the first nozzle needle 8 causes the first nozzle needle 8 to close.

A noteworthy feature of the injection nozzle 1 according to the present invention is that when the first nozzle needle 8 is open, it is possible to open and close the second nozzle needle 15 independently of the first nozzle needle 8. This allows for particularly wide latitudes regarding the actuation of the injection nozzle 1. It is also significant that only a single actuator or only a single control piston 38 is required for directly triggering the first nozzle needle 8 and second nozzle needle 15 independently of each other. The expense required for this is comparatively low.

In the injection nozzle 1 according to the present invention, the first hydraulic pressure transmission path 44 is thus permanently active, whereas the present invention permits the second hydraulic pressure transmission path 47 to be activated and deactivated. The second hydraulic transmission path 47 is activated and deactivated as a function of the control piston stroke, thus achieving a stroke-controlled switching between the activated state and the deactivated state for the second hydraulic pressure transmission path 47. For the stroke distance 53 of the control piston 38 at which the second hydraulic pressure transmission path 47 is switched between the activated and deactivated state, is suitably set to a predetermined switching value. The predetermined stroke distance 53 is thus also referred to below as the switching value 53. The switching value 53 is suitably selected so that with an opening stroke motion of the control piston 38, before the switching value 53 is reached or at the very latest, when it is reached, the first nozzle needle 8 is opened far enough to be able to execute a normal fuel injection through the at least one first injection opening 5. Only when the control piston 38 is moved beyond the switching value 53 in the opening direction 52 does the second nozzle needle 15 also open in order to execute a fuel injection through the at least one second injection opening 6.

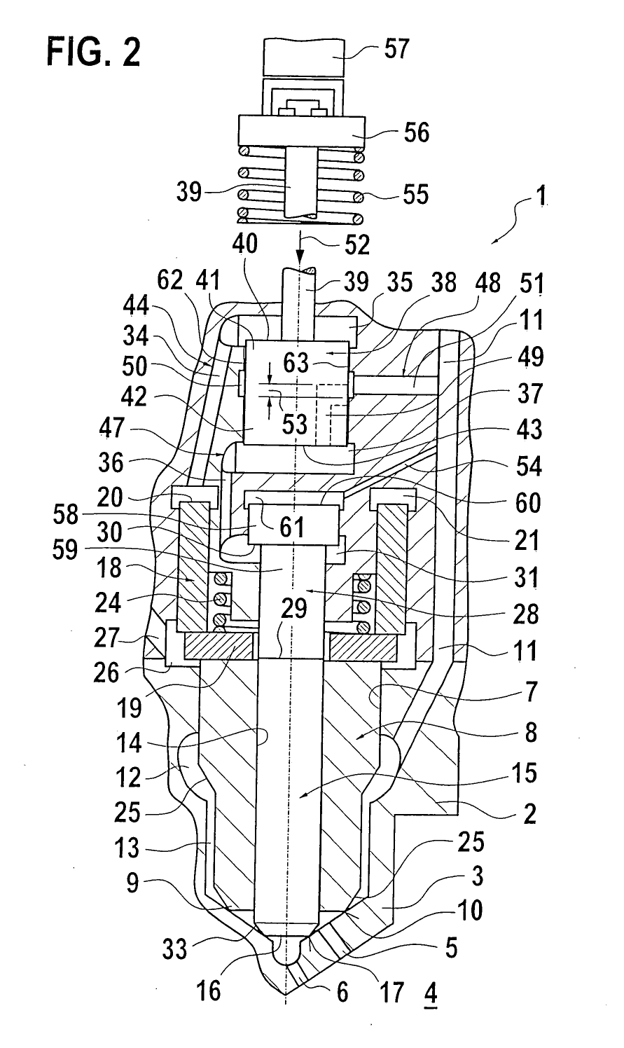

FIG. 2 shows a second exemplary embodiment of the injection nozzle 1 according to the present invention; due to similarities to the first exemplary embodiment according to FIG. 1 with regard to components and functions, reference is hereby made to the relevant statements made in relation to FIG. 1 and only the differences will be explained below.

According to FIG. 2, it is possible for a return spring 55 to prestress the control piston 38 in the direction counter to the opening direction 52. In the variant depicted here, this return spring 55 rests against the nozzle body 2 at one end and at the other end, rests against an actuator piston 56 that is driven directly by an actuator 57, in particular piezoelectric actuator.

In this case, the second drive piston 28 has a piston head 58 and a piston rod 59. It is possible for these components to be attached to each other or to be of one piece with each other; it is also possible for them to rest loosely against each other and remain in contact with each other even during stroke motions due to the compressive forces acting on them. The second drive piston 28 here has a second compensator surface 60 that is situated in a second compensator chamber 61 and can be subjected to pressure therein. The compensator conduit 54 connects the second compensator chamber 61 to the supply line 11. The second compensator surface 60 in this case is oriented in the opposite direction from the second booster surface 30 and is consequently oriented away from the injection openings 5, 6 so that the second compensator surface 60 acts in the closing direction of the second nozzle needle 15 when subjected to pressure. By contrast with the variant according to FIG. 1, in the embodiment form according to FIG. 2, no first compensator surface 22 and no first compensator chamber 23 are provided.

The second booster surface 30 also acts in the opening direction of the second nozzle needle 15 when subjected to pressure. The first booster surface 20 here acts in the closing direction of the first nozzle needle 8 when subjected to pressure. In addition, the second nozzle needle 15 here does not require an associated second spring 32.

The first control chamber 35 communicates with the annular chamber 50 via a throttle segment 62 so that the first control chamber 35 communicates with the supply line 11 in a throttled manner. The throttle segment 62 is situated radially between the control piston 38 and a control piston guide 63. The throttle segment 62 is designed and dimensioned so that in static states of the control piston 38 and/or in slow movements of the control piston 38, a pressure compensation occurs between the first control chamber 35 and the supply line 11, whereas during dynamic events, in particular with rapid adjusting strokes of the control piston 38, a pressure compensation between the first control chamber 35 and the supply line 11 either cannot occur at all or cannot occur rapidly enough.

The embodiment form of the injection nozzle 1 according to the present invention shown in FIG. 2 functions as follows:

In the initial position depicted in FIG. 2, the high pressure of the supply line 11 is present in the first hydraulic pressure transmission path 44, yielding a balance of forces acting on the first nozzle needle 8, whose resultant acts in the closing direction. The first pressure shoulder 25 here works in opposition to the closing forces of the first spring 24 and first booster surface 20. The first nozzle needle 8 is thus closed. In addition, the hydraulic connection 48 is open so that the same pressure as in the supply line 11 is present in the second hydraulic pressure transmission path 47. The second hydraulic pressure transmission path 47 is thus deactivated. When the first nozzle needle 8 is closed, the second pressure shoulder 33 is relatively unpressurized. All in all, this yields a balance of forces for the first nozzle needle 15 that has a resulting force acting in the closing direction so that the second nozzle needle 15 is also closed.

If a fuel injection should now be executed by means of the at least one first injection opening 5, the actuator 57 triggers the control piston 48 so that it executes a stroke motion in the opening direction 52 that is smaller than the stroke distance 53, which constitutes the switching value 53 in this instance as well. An opening stroke motion of the control piston 38 increases the volume of the first control chamber 53. Since the movement of the control piston 38 occurs at a very high actuation speed, the throttle segment 62 is virtually closed so that the opening stroke motion of the control piston 38 causes a pressure drop in the first control chamber 35. The first control conduit 34 transmits this pressure drop to the first booster chamber 21. This changes the balance of forces acting on the first nozzle needle 8, yielding a resulting force that now acts in the opening direction. As a result, the first nozzle needle 8 lifts away from the first sealing seat 10 and the at least one first injection opening 5 communicates with the nozzle chamber 12. When the first nozzle needle 8 is open, the at least one first injection opening 5 is able to execute the desired injection. With the opening of the first nozzle needle 8, pressure is also exerted against the second pressure shoulder 33, which reduces the resulting closing force acting on the second nozzle needle 15.

With the opening stroke motion of the control piston 38, its second control surface 43 plunges deeper into the second control chamber 37, thus reducing the volume in the second control chamber 37. When the second hydraulic pressure transmission path 47 is deactivated, though, pressure cannot build up in the second control chamber 37 since the displaced hydraulic fluid, i.e. fuel, is able to escape into the supply line 11 via the open hydraulic connection 48.

If it is then necessary to inject a larger quantity of fuel per unit time, it is possible to execute the injection also by means of the at least one second injection opening 6. To this end, the actuator 57 triggers the control piston 48 to execute an opening stroke motion that travels beyond the switching value 53, as a result of which the hydraulic connection 48 is closed once the switching value or stroke distance 53 is exceeded. As a result, the second hydraulic pressure transmission path 47 is activated for stroke movements of the control piston 38 that travel beyond the switching value 53. Consequently, the volume reduction of the second control chamber 37 produces a pressure increase in the second control chamber 37, which the second control conduit 36 transmits to the second booster chamber 31.

The opening force exerted on the second booster surface 30 consequently increases, which changes the balance of forces acting on the second nozzle needle 15 so that now, the opening forces predominate and the second nozzle needle 15 lifts away from the second sealing seat 17. This connects the at least one second injection opening 6 to the nozzle chamber 12, enabling it to inject fuel into the combustion chamber or premixing chamber 4.

In order to close the second nozzle needle 15, the control piston 38 is moved back until the hydraulic connection 48 is opened and consequently the second hydraulic pressure transmission path 47 is once again deactivated and the pressure in the second booster chamber 31 decreases again.

The closing of the first nozzle needle 8 occurs in a corresponding way in that the control piston 48 is moved back into its initial position. The resulting volume decrease in the first control chamber 35 causes a pressure increase in the first control chamber 35, which is transmitted into the first booster chamber 21, yielding a corresponding closing force therein acting on the first booster surface 20.

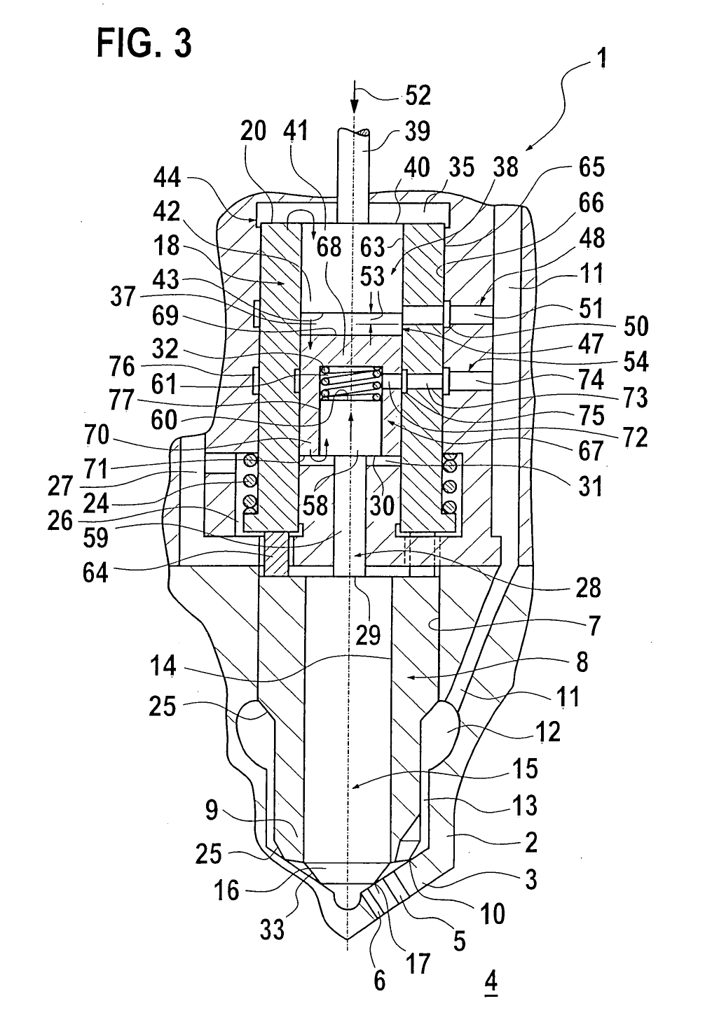

FIG. 3 shows a third exemplary embodiment of the injection nozzle 1 according to the present invention; here, too, due to similarities to the above-described examples with regard to components and functions, reference is hereby made to the relevant statements made in relation to FIGS. 1 and 2, and only the differences will be explained below.

In the embodiment form of the injection nozzle 1 shown here in FIG. 3, the first drive piston 18 is drive-connected to the first nozzle needle 8 via a number of pins 64; it is possible for the pins 64 to be embodied as separate components or for them to be of one piece with the first drive piston 18 and/or the first nozzle needle 8.

The first booster surface 20 here is situated in the first control chamber 35, thus obviating the need for a separate first booster chamber 21 here. This design simplifies the first hydraulic pressure transmission path 44 since it is possible for the surfaces that are connected to each other, namely the first booster surface 20 and the first control surface 40, to be situated in the same chamber, namely the first control chamber 35.

As in the variant according to FIG. 2, in the embodiment form depicted here, the first control chamber 35 communicates with the supply line 11 via a throttle segment 65. The throttle segment 65 here extends radially between the first drive piston 18 and a piston guide 66 embodied in the nozzle body 2. The throttle segment 65 is consequently connected to the annular chamber 50 of the hydraulic connection 48. It is also possible for the throttle segment 65 to be situated radially between the control piston 38 and the first drive piston 18.

It is alternatively possible for the supply of pressure into the first control chamber 35, to occur in a manner analogous to the embodiment form according to FIG. 1, by means of an inlet line 45 with an inlet valve 46 that connects the first control chamber 35 to the supply line 11.

Another feature of this embodiment form is that the control piston guide 63 here is situated in the first drive piston 18, which is embodied in the form of a hollow cylinder for this purpose. The control piston 38 is thus situated coaxially inside the first drive piston 18 and is supported so that it is able to execute a stroke motion therein.

In the embodiment form depicted here, the second hydraulic pressure transmission path 47 includes a coupling piston 67 that is likewise supported so that it is able to execute a stroke motion in the first drive piston 18. At a first end 68 oriented away from the injection openings 5, 6, the coupling piston 67 has a first coupling surface 69 that is situated in the second control chamber 37 and can be subjected to pressure therein. The first coupling surface 69 is thus oriented in the opposite direction from the second control surface 63. At a second end 70 oriented away from the first end 68, the coupling piston 67 has a second coupling surface 71 that is situated in the second booster chamber 31 and oriented in the opposite direction from the first coupling surface 69.

The coupling piston 67 is embodied in the form of a hollow cylinder that is open at one end and is slid onto the end of the second drive piston 28 oriented away from the injection openings 5, 6. In other words, the second drive piston 28 is supported so that its piston head 58 is able to execute a stroke motion in the coupling piston 67. Consequently, the second compensator chamber 61 is contained in the coupling piston 67; the second spring 32 is also supported against the coupling piston 67 in the second compensator chamber 61. A first segment 72 of the compensator conduit 54 for connecting the second compensator chamber 61 to the supply line 11 is provided inside the coupling piston 67. A second segment 73 of the compensator conduit 54 is provided in the first drive piston 18. Finally, a third segment 74 of the compensator conduit 54 is provided in the nozzle body 2. The compensator conduit segments 72, 73, 74 are dimensioned and positioned so as to assure a communicating connection between the compensator chamber 61 and the supply line 11 for all relative positions of the nozzle body 2, the first drive piston 18, and the coupling piston 67 that occur during normal operation. It is possible for additional annular chambers 75 and 76 to be provided for this purpose; the one annular chamber 75 is embodied in the region of the first compensator conduit segment 72 in the first drive piston 18, whereas the other annular chamber 76 is provided in the region of the second compensator conduit segment 73 in the nozzle body 2.

The embodiment form of the injection nozzle 1 according to present invention shown in FIG. 3 functions as follows:

In the initial position depicted in FIG. 3, both of the nozzle needles 8, 15 are closed. The high pressure of the supply line 11 is present in the first control chamber 35. The hydraulic connection 48 is open so that the high pressure of the supply line 11 is also present in the second control chamber 37. The high pressure of the supply line 11 is also present in the second compensator chamber 61. The same pressure as in the supply line 11 is also suitably present in the second booster chamber 31. This is made possible, for example, by means of an additional throttle segment 77 that is situated radially between the coupling piston 67 and the piston head 58 of the second drive piston 28 and connects the second compensator chamber 61 to the second booster chamber 31.

In order to open the first nozzle needle 8, the control piston 38 is moved in the opening direction 52. This produces a pressure drop in the first control chamber 35, which also acts directly on the first booster surface 20. This changes the balance of forces acting on the first nozzle needle 8, thus yielding a resulting force acting in the opening direction. As a result, the first nozzle needle 8 lifts away from the first sealing seat 10.

If only the first nozzle needle 8 is to be opened, then the control piston 38 executes a stroke movement less than the predetermined stroke distance 53 or less than the predetermined switching value 53 so that the hydraulic connection 48 remains open during the movement of the control piston 38. When the hydraulic connection 48 is open, the second hydraulic transmission path 47 is deactivated. It is thus possible for the volume of the second control chamber 37 to be reduced without resulting in a pressure increase in the second control chamber 37. The volume that is displaced by the control piston 38 plunging into the second control chamber 37 is able to escape into the supply line 11 via the open hydraulic connection 48.

If it then becomes necessary to also open the second nozzle needle 15, the control piston 38 is then moved beyond the switching value 53 in the opening direction 52. When the stroke distance 53 is exceeded, the hydraulic connection 48 is closed so that the second hydraulic pressure transmission path 47 is hermetically closed, at least with respect to dynamic events. The second hydraulic pressure transmission path 47 is thus activated. A stroke movement of the control piston 38 beyond the switching value 53 then leads to a pressure increase in the second control chamber 37, which acts on the first coupling surface 69. As a result, the coupling piston 67 is likewise moved in the opening direction 52 of the control piston 38. This opening stroke of the coupling piston 67 produces a pressure increase in the second booster chamber 31, which drives the second drive piston 28 in the opening direction of the second nozzle needle 15. The balance of forces acting on the second nozzle needle 15 consequently changes so that the opening forces predominate and the second nozzle needle lifts away from the second sealing seat 17.

The closing of the second nozzle needle 15 and first nozzle needle 8 occurs in a corresponding way when the control piston 38 travels back into its initial position.

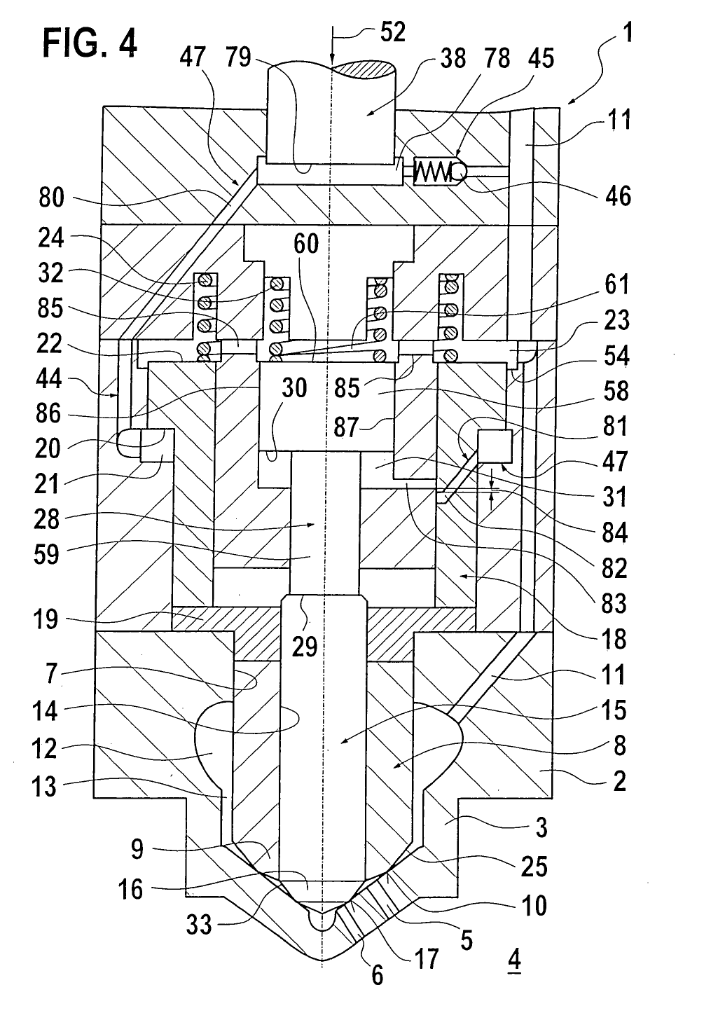

FIG. 4 shows a fourth exemplary embodiment of the injection nozzle 1 according to the present invention; here, too, due to similarities to the above-described exemplary embodiments with regard to components and functions, reference is hereby made to the relevant statements made in relation to FIGS. 1 through 3, and only the differences will be explained below.

In the variant according to FIG. 1, only a single control chamber 78 is provided; a control surface 79 of the control piston 38 that plunges into the control chamber 78 is contained in this control chamber 78 and can be subjected to pressure therein. The control chamber 78 communicates with the first booster chamber 21 via a control conduit 80. The first hydraulic pressure transmission path 44 consequently extends from the control surface 79 to the first booster surface 20.

By contrast, the second hydraulic pressure transmission path 47 leads from the control surface 79 to the second booster surface 30. This means that the first hydraulic pressure transmission path 44 and the second hydraulic pressure transmission path 47 lead jointly from the control chamber 78 to the first booster chamber 21, i.e. the first hydraulic pressure transmission path 44 constitutes a first segment of the second hydraulic transmission path 47.

In the present exemplary embodiment, the second hydraulic pressure transmission path 47 includes a hydraulic connection 81 that permits the first booster chamber 21 to communicate with the second booster chamber 31. This hydraulic connection 81 is controllable, i.e. it can be opened and closed. The two booster chambers 21, 31 communicate with each other when the hydraulic connection 81 is open, but do not when the hydraulic connection 81 is closed. When the hydraulic connection 81 is closed, the second hydraulic pressure transmission path 47 is disconnected so that no pressure is transmitted from the control surface 79 to the second booster surface 30. This means that the second hydraulic pressure transmission path 47 is deactivated when the hydraulic connection 81 is closed. By contrast, it is possible for pressures to be transmitted from the control surface 79 to the second booster surface 30 when the hydraulic connection 81 is open; in other words, when the hydraulic connection 81 is open, the second hydraulic pressure transmission path 47 is activated.

The hydraulic connection 81 is comprised of at least one first connecting conduit 82 and at least one second connecting conduit 83. The first connecting conduit 82 is contained in the first drive piston 18 and feeds into the first booster chamber 21. The second connecting conduit 83 is contained in the nozzle body 2 and feeds into the second booster chamber 31. The ends of the connecting conduits 82, 83 oriented away from the respective booster chambers 21, 31 are oriented in relation to each other so that they are spaced apart from each other in the stroke direction in the initial position depicted here, in which the two nozzle needles 8, 15 are closed. The distance of this spacing corresponds to a stroke distance 84 of the first nozzle needle 8 or a switching value 84. The hydraulic connection 81 is thus closed in the initial position, i.e. the second hydraulic transmission path 47 is deactivated. Only when the first drive piston 18 and the first nozzle needle 8 connected to it execute an opening stroke that travels beyond the stroke distance 84 or switching value 84 do the two ends of the connecting conduits 82, 83 oriented toward each other come into line, thus opening the hydraulic connection 81 and consequently activating the second hydraulic pressure transmission path 47.

By contrast with the exemplary embodiments illustrated above, in the injection nozzle 1 shown here, the first drive piston 18 and the second drive piston 28 are each provided with a respective compensator chamber 23 and 61. The two compensator chambers 23, 61 communicate with each other via lateral bores 85 and communicate with the supply line 11 via the compensator conduit 54.

The embodiment form of the injection nozzle 1 according to present invention shown in FIG. 4 functions as follows:

In the initial position depicted in FIG. 4, both of the nozzle needles 8, 15 are closed. The high pressure of the supply line 11 is present in the single control chamber 78. This high pressure is thus also present in the first booster chamber 21. A throttle segment 86, which is embodied for example radially between the piston head 58 of the second drive piston 28 and an associated piston guide 87 of the nozzle body 2 and connects the second compensator chamber 81 to the second booster chamber 31 in a throttled fashion, achieves a pressure compensation between the second compensator chamber 61 and the second booster chamber 31, at least during static or quasi-static states. Consequently, the high pressure of the supply line 11 is also present in the second booster chamber 31 in the initial state.

If a fuel injection is to be executed by means of the at least one first injection opening 5, then the control piston 38 is actuated in the opening direction 52. This causes the control piston 38 to plunge into the control chamber 78, thus reducing the volume of the control chamber 78. This produces an increase in the pressure acting on the control surface 79, which the first hydraulic pressure transmission path 44 transmits to the first booster chamber 21 and the first booster surface 20. Since the hydraulic connection 81 is closed in the initial state and the second hydraulic pressure transmission path 47 is consequently deactivated, the increased pressure on the control surface 79 cannot be transmitted to the second booster chamber 31 and the second booster surface 30.

The pressure increase in the first booster chamber 21 changes the balance of forces acting on the first nozzle needle 8, yielding a resulting force acting in the opening direction. As a result, the first nozzle needle 8 lifts away from the first sealing seat 10. When the second hydraulic pressure transmission path 47 is deactivated, the pressure in the second booster chamber 31 remains constant so that the second nozzle needle 15 does not lift up even if its second pressure shoulder 33 is subjected to pressure when the first nozzle needle 8 is open. The second nozzle needle 15 therefore remains closed. The opening stroke movement of the control piston 38 is dimensioned so that the opening stroke of the first drive piston 18 remains less than the predetermined stroke distance 84.

If an additional fuel injection is also to be executed by means of the at least one second injection nozzle 6, then the control piston 38 is actuated so that it plunges even further into the control chamber 78 in the opening direction 52. This increases the opening stroke of the first nozzle needle 8 and therefore of the first drive piston 18. As soon as the opening movement of the first drive piston 18 reaches or exceeds the switching value 84, the facing ends of the connecting conduits 82, 83 oriented toward each other come into line, thus opening the hydraulic connection 81, which activates the second hydraulic pressure transmission path 47. The second hydraulic transmission path 47 is then able to transmit the pressure acting on the control surface 79 to the second booster surface 30 so that a pressure increase occurs in the second booster chamber 31. This changes the balance of forces acting on the second nozzle needle 15, yielding a resulting force that now acts in the opening direction. As a result, the second nozzle needle 15 then lifts away from the second sealing seat 17.

The closing of the second nozzle needle 15 and first nozzle needle 8 correspondingly occurs in a reverse sequence when the control piston 38 travels back into its initial position.

An essential difference between the variants shown in FIGS. 1 through 3 and the embodiment form shown in FIG. 4 is that in the fourth embodiment form, the first drive piston 18 functions as a control slide valve so that the switching between the activated state and the deactivated state of the second hydraulic pressure transmission path 47 is controlled directly as a function of the stroke position of the first nozzle needle 8. This permits a particularly precise establishment of a predetermined preliminary stroke for the first nozzle needle 8 up to which the first nozzle needle 8 should lift away from the first sealing seat 10 before the second nozzle needle 15 opens. But since the stroke motion of the first nozzle needle 8 correlates to the stroke motion of the control piston 38, this also provides an (indirect) control of the second hydraulic pressure transmission path 47 as a function of a predetermined control piston stroke.

By contrast, in the other embodiment forms shown, the second hydraulic pressure transmission path 47 is controlled directly as a function of the predetermined control piston stroke since the control piston 38 therein functions as a slide valve that opens or closes the hydraulic connection 48. Since the opening motion of the control piston 38 correlates to the opening motion of the first nozzle needle 8, it is also possible to more or less precisely establish a desired preliminary stroke for the first nozzle needle 8 through an appropriate selection of the switching value 53.

All of the embodiment forms share the feature that only a single control piston 38 and therefore also only a single actuator is required in order to directly trigger the two nozzle needles 8, 15 to open separately or in sequence. This yields a particularly simple and therefore inexpensive design for the injection nozzle 1.

Although four different embodiment forms have been described in detail by way of example here, it is clear that these do not exhaust the possibilities of the present invention and that it is possible for individual characteristics of different embodiment forms to be combined with one another and/or interchanged with one another.

1-14. (canceled)

15. An injection nozzle for an internal combustion engine, in particular in a motor vehicle, the injection nozzle comprising,
a nozzle body (2) equipped with at least one first injection opening (5) and at least one second injection opening (6),
a first nozzle needle (8), which is embodied in the form of a hollow needle, is guided in a first needle guide (7) of the nozzle body (2) for controlling the injection of fuel through the at least one first injection opening (5),
a second nozzle needle (15) disposed coaxial to the first nozzle needle (8) for controlling the injection of fuel through the at least one second injection opening (6),
a control piston (38) that is drive-coupled to an actuator (57),
a first drive piston (18) which is drive-connected to the first nozzle needle (8) and having a first booster surface (20) hydraulically coupled to a control surface (40; 79) of the control piston (38), by a first hydraulic pressure transmission path (44), and
a second drive piston (28) drive-coupled to the second nozzle needle (15) and having a second booster surface (30) hydraulically coupled to a control surface (43; 79) of the control piston (38), by an activatable and deactivatable second hydraulic pressure transmission path (47),
the activation and deactivation of the second hydraulic pressure transmission path (47) being controlled as a function of the control piston stroke.

16. The injection nozzle according to claim 15, wherein a control piston stroke at which the second hydraulic pressure transmission path (47) switches between its activated and deactivated state is predetermined so that with an opening stroke motion of the control piston (38) up until it reaches this predetermined control piston stroke, the first nozzle needle (8) executes an opening stroke while the second nozzle needle (15) remains in its closed position and with an opening stroke motion of the control piston (38) that travels beyond this predetermined control piston stroke, the second nozzle needle (15) also executes an opening stroke.

17. The injection nozzle according to claim 15, wherein a first end (41), the control piston (38) has a first control surface (40) situated in a first control chamber (35) and at a second end (42) oriented away from the first end (41), the control piston (38) has a second control surface (43) situated in a second control chamber (37),
the first hydraulic pressure transmission path (44) coupling the first control surface (40) to the first booster surface (20), and
the second hydraulic pressure transmission path (47) is able to couple the second control surface (42) to the second booster surface (30).

18. The injection nozzle according to claim 16, wherein a first end (41), the control piston (38) has a first control surface (40) situated in a first control chamber (35) and at a second end (42) oriented away from the first end (41), the control piston (38) has a second control surface (43) situated in a second control chamber (37),
the first hydraulic pressure transmission path (44) coupling the first control surface (40) to the first booster surface (20), and
the second hydraulic pressure transmission path (47) is able to couple the second control surface (42) to the second booster surface (30).

19. The injection nozzle according to claim 17, further comprising
a controllable hydraulic connection (48) for connecting the second control chamber (37) to a supply line (11) that supplies highly pressurized fuel to the injection openings (5, 6),
the hydraulic connection (48) being controlled to open and close as a function of the control piston stroke position, and
the second hydraulic pressure transmission path (47) being deactivated when the hydraulic connection (48) is open and being activated when the hydraulic connection (48) is closed.

20. The injection nozzle according to claim 17, wherein
the first booster surface (20) is located in a first booster chamber (21) that communicates with the first control chamber (35) via a first control conduit (34), and
the second booster surface (30) is located in a second booster chamber (31) that communicates with the second control chamber (37) via a second control conduit (36).

21. The injection nozzle according to claim 19, wherein
the first booster surface (20) is located in a first booster chamber (21) that communicates with the first control chamber (35) via a first control conduit (34), and
the second booster surface (30) is located in a second booster chamber (31) that communicates with the second control chamber (37) via a second control conduit (36).

22. The injection nozzle according to claim 17, wherein the first booster surface (20) is located in the first control chamber (35).

23. The injection nozzle according to claim 19, wherein the first booster surface (20) is located in the first control chamber (35).

24. The injection nozzle according to claim 17, wherein
the second hydraulic pressure transmission path (47) contains a coupling piston (67) that has a first coupling surface (69), which is contained in the second control chamber (37) and is situated at a first end (68), and has a second coupling surface (71), which is contained in a booster chamber (31) and is situated at a second end (70) opposite from the first end (68), and
the second booster surface (30) is situated in the booster chamber (31).

25. The injection nozzle according to claim 19, wherein
the second hydraulic pressure transmission path (47) contains a coupling piston (67) that has a first coupling surface (69), which is contained in the second control chamber (37) and is situated at a first end (68), and has a second coupling surface (71), which is contained in a booster chamber (31) and is situated at a second end (70) opposite from the first end (68), and
the second booster surface (30) is situated in the booster chamber (31).

26. The injection nozzle according to claim 22, wherein
the second hydraulic pressure transmission path (47) contains a coupling piston (67) that has a first coupling surface (69), which is contained in the second control chamber (37) and is situated at a first end (68), and has a second coupling surface (71), which is contained in a booster chamber (31) and is situated at a second end (70) opposite from the first end (68), and
the second booster surface (30) is situated in the booster chamber (31).

27. The injection nozzle according to claim 24, wherein the coupling piston (67) is supported coaxially in the first drive piston (18) and is able to execute a stroke motion therein, or the coupling piston (67) is supported coaxially on the second drive piston (28) and is able to execute a stroke motion thereon.

28. The injection nozzle according to claim 19, wherein a segment (49) of the hydraulic connection (48) is contained in the control piston (38).

29. The injection nozzle according to claim 15,
the control piston (38) comprises a control surface (79) situated in a control chamber (78),
wherein the first hydraulic pressure transmission path (44) couples the control surface (79) to the first booster surface (20), and
wherein the second hydraulic pressure transmission path (47) is able to couple the control surface (79) to the second booster surface (30).

30. The injection nozzle according to claim 16,
the control piston (38) comprises a control surface (79) situated in a control chamber (78),
wherein the first hydraulic pressure transmission path (44) couples the control surface (79) to the first booster surface (20), and
wherein the second hydraulic pressure transmission path (47) is able to couple the control surface (79) to the second booster surface (30).

31. The injection nozzle according to claim 24, wherein
the second hydraulic pressure transmission path (47) comprises a controllable hydraulic connection (81) that is able to connect a first booster chamber (21), which contains the first booster surface (20), to a second booster chamber (31), which contains the second booster surface (30),
wherein the hydraulic connection (81) is controlled to open and close as a function of the control piston position, and
wherein the second hydraulic pressure transmission path (47) is activated when the hydraulic connection (81) is open and is deactivated when the hydraulic connection (81) is closed.

32. The injection nozzle according to claim 31, wherein a segment (82) of the hydraulic connection (81) is contained in the first drive piston (18).

33. The injection nozzle according to claim 17, wherein the second drive piston (28) has a compensator surface (60), which is oriented away from the second booster surface (30) and situated in a compensator to chamber (61) that communicates with the supply line (11).

34. The injection nozzle according to 17, wherein the first drive piston (18) has a compensator surface (22), which is oriented away from the first booster surface (20) and situated in a compensator chamber (23) that communicates with the supply line (11).
